(19) United States
(12) Patent Application Publication
(10) Pub. No.: US 2009/0126007 A1
(43) Pub. Date: May 14, 2009

(54) IDENTITY MANAGEMENT SUITE

(75) Inventors: Jennie ZAMBERLAN, Richfield, OH (US); Brian JIMERSON, Akron, OH (US); Anthony STANLEY, Middleburg Heights, OH (US)

Correspondence Address: HAHN LOESER & PARKS, LLP, One GOJO Plaza, Suite 300, AKRON, OH, 44311-1076, US

(73) Assignee: AVANTIA, INC., Valley View, OH (US)

(21) Appl. No.: 11/936,966

(22) Filed: Nov. 8, 2007

(51) Int. Cl. H04L 9/32

(52) U.S. Cl. 726/19; 726/17

(57) ABSTRACT

A server platform hosting an integrated software-based identity management suite used in a system for authenticating users with respect to a legacy application. The identity management suite includes an administration console for domain administration, an authentication services module for user authentication, an activity intelligence engine for monitoring user activity, an open-source-based virtual layer for mapping fields of a legacy user directory to fields within the server platform, and an internal interface using an open communication protocol adapted to provide communication between the open-source-based virtual layer and at least the authentication services module within the server platform.

### TECHNICAL FIELD

Certain embodiments of the present invention relate to identity management. More particularly, certain embodiments of the present invention relate to fully integrated systems and methods providing identity management with respect to a legacy application.

### BACKGROUND

Computer systems have progressed to where it is possible for a user to remotely access software applications (e.g., a multiple listing service (MLS) for real estate) via a computer. In providing access to such software applications, it is desirable that only authorized users be able to access any particular application. Many organizations that provide web-based access to applications often struggle with piecing together an identity management structure over time in an attempt to prevent unauthorized users from accessing their applications. Such identity management structures may be difficult to maintain and update, and may end up not being as effective as desired.

There is a need for a reliable, effective, and fully integrated approach that can be easily adapted to the needs of different organizations and administrators to provide identity management with respect to their legacy applications.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY

A system, methods, and an integrated software suite hosted on a server platform for providing identity management with respect to use of a legacy application are disclosed. The integrated software suite constitutes a cohesive integrated product that may be used by service providers in conjunction with their own legacy applications hosted on their own servers. Such an integrated software suite leverages open source protocols and plug-in legacy directories and is easily configurable by a service provider such that the service provider can avoid having to perform complex and time-consuming identity management integration themselves.

An embodiment comprises a server platform hosting an integrated software-based identity management suite. The identity management suite includes an administration console for domain administration, an authentication services module for user authentication, an activity intelligence engine for monitoring user activity and performing user auditing and metrics, and an open-source-based virtual layer for mapping fields of a legacy user directory to fields within the server platform. The identity management suite further includes an internal interface using an open communication protocol adapted to provide communication between the open-source-based virtual layer and at least the authentication services module within the server platform.

The open-source-based virtual layer may comprise a virtual LDAP layer and the open communication protocol may comprise an LDAP communication protocol. The server platform may further include a legacy user directory. Also, the server platform may further include an application program interface (API) capable of facilitating access to the legacy user directory. The identity management suite may include an XML-based protocol interface to communicate with an external legacy server hosting a legacy application.

The administration console includes an administrator user interface adapted to provide user-friendly web-based communication between the server platform and an external administrator computer-based platform. Furthermore, the administration console supports HOTP provisioning. The server platform may include a wireless network interface to support HOTP provisioning.

Another embodiment comprises a computer readable medium having stored thereon an integrated software suite for identity management. The integrated software suite includes an administration console for domain administration, an authentication services module for user authentication, an activity intelligence engine for monitoring user activity, an application program interface (API) capable of facilitating access to a legacy user directory, a virtual LDAP layer for mapping fields of the legacy user directory to defined fields within the software suite, and an internal LDAP communication protocol interface adapted to provide communication between the virtual LDAP layer and the authentication services module.

In the integrated software suite, the administration console may include an administrator user interface adapted to provide user-friendly web-based communication between a server platform hosting the software suite and an external administrator computer-based platform. The integrated software suite may include an XML-based protocol interface to communicate with an external legacy server hosting a legacy application. The administration console may support HOTP provisioning and the integrated software suite may include a wireless network interface for supporting HOTP provisioning.

A data structure related to authentication functionality may be stored on the computer readable medium. The data structure may include a first field capable of containing data representing a user name, a second field capable of containing data representing a user password, and a third field capable of containing data representing a HOTP personal identification number (PIN).

Another data structure related to authentication functionality may be stored on the computer readable medium. The data structure may include a first field capable of containing data representing a legacy application, a second field capable of containing data representing a role, at least a third field capable of containing data representing at least one permission, at least a fourth field capable of containing data representing at least one group, and at least a fifth field capable of containing data representing at least one user.

A data structure related to activity intelligence functionality may be stored on the computer readable medium. The data structure may include a first field capable of containing data representing a legacy application, at least a second field capable of containing data representing at least one threshold, and at least a third field capable of containing data representing at least one alert,

A further embodiment comprises an application program interface embodied on a computer-readable medium for execution on a legacy server platform in conjunction with a legacy application program. The application program interface is capable of delivering user identification information and receiving legacy user directory information in response to the delivered user identification information. The application program interface may be Java-based, .NET-based, or SAML-based. The delivering and receiving are respectively to and from an identity management server platform via an XML-based protocol. The user identification information may include a user name, a user password, and/or a HOTP-generated pass code. The legacy user directory information includes data corresponding to the legacy application program for a user, a user name and password, a group associated with the user name and password, a role associated with the group, and a permission associated with the role.

Another embodiment comprises a server platform hosting an integrated software-based identity management suite. The identity management suite includes means for providing domain administration services, means for providing authentication services, means for providing activity intelligence services, means for facilitating access to a legacy user directory, means for mapping legacy user directory fields to server platform fields, and means for communicating the server platform fields to the means for providing authentication services.

The server platform may further include means for providing user-friendly communication between the server platform and an external administrator computer-based platform. The server platform may further include means for communicating with an external legacy server hosting a legacy application. The server platform may further include means for supporting HOTP provisioning.

A further embodiment comprises a system providing identity management with respect to a legacy application. The system includes a first server platform hosting an integrated software-based identity management suite, at least one administrator computer-based platform operationally interfacing to the first server platform, and a second server platform hosting a legacy application and operationally interfacing to the first server platform via a secure web-based connection.

The first server platform may include at least one legacy user directory. The software-based identity management suite may include an application program interface (API) capable of facilitating access to a legacy user directory. The second server platform may include at least one legacy user directory. The second server platform may include an application program interface (API) capable of facilitating access to the legacy user directory.

The system may further include at least one wireless device wirelessly interfacing to the first server platform to provide HOTP provisioning to the wireless device. Alternatively, the system may include at least one computer-based platform operationally interfacing to the first server platform to provide HOTP provisioning to the computer-based platform.

The software-based integrated identity management suite includes an administration console for domain administration, an authentication services module for user authentication, an activity intelligence engine for monitoring user activity, a virtual LDAP layer for mapping fields of a legacy user directory to defined fields within the software suite, and an internal LDAP communication protocol interface adapted to provide communication between the virtual LDAP layer and the authentication services module.

The administration console includes an administrator user interface adapted to provide user-friendly web-based communication between the first server platform and the administrator computer-based platform. The administration console further supports HOTP provisioning. The identity management suite further includes an XML-based protocol interface to communicate with the second server platform.

Another embodiment comprises a method to authenticate a user for use of a legacy application hosted on a legacy server. The method includes sending an application request from a user browser to a legacy server of a service provider of a legacy application. The method further includes the legacy server re-directing the application request to an identity management server via the user browser. The method also includes the identity management server sending a user login form to the user browser in response to receiving the re-directed application request. The method further includes the user browser sending user login information to the identity management server in response to a user of the user browser filling out the user login form. The method also includes the identity management server authenticating the user with respect to the legacy application in response to the user login information. The method further includes the legacy server validating the security assertion information and the legacy server sending application data corresponding to the legacy application to the user browser in response to validating the security assertion information.

The user login information may include a user name, a user password, and/or a HOTP user pass code. The security assertion information may include user directory information obtained from a legacy user directory on the identity management server as part of the authenticating step. The security assertion information may include user directory information obtained from a legacy user directory on the legacy server as part of the authenticating step. The user directory information may include data representing the legacy application for the user, a user name and password, a group associated with the user name and password, a role associated with the group, and a permission associated with the role.

A further embodiment comprises a method of provisioning a new user for a legacy application hosted on a legacy server using an identity management server hosting an integrated software-based identity management suite. The method includes launching an administration console on the identity management server, adding new user information to the identity management server via the administration console to establish the new user, establishing a HOTP personal identification number (PIN) for the new user within the identity management server via the administration console, communicating the HOTP PIN from the identity management server to a wireless mobile device of the user, communicating a deploy link from the identity management server to the wireless mobile device of the user, and the user following the deploy link using the wireless mobile device to download a HOTP key generator from the identity management server to the mobile wireless device.

The method may further include the user entering the HOTP PIN into the wireless mobile device to activate the HOTP key generator. The new user information may include data representing the legacy application for the user, at least one threshold associated with the legacy application, at least one alert associated with the threshold, a user name and password, a group associated with the user name and password, a role associated with the group, and a permission associated with the role.

These and other advantages and novel features of the present invention, as well as details of illustrated embodiments thereof, will be more fully understood from the following description and drawings.

### BRIEF DESCRIPTION OF THE DRAWINGS

FIG. 1 illustrates a schematic block diagram of a logical view of an exemplary embodiment of a system providing identity management with respect to a legacy application;

FIG. 2 illustrates a logical flow diagram of an exemplary embodiment of a method of creating and provisioning a new user in the system of FIG. 1;

FIG. 3 illustrates a flow chart of an exemplary embodiment of a method of creating and provisioning a new user in the system of FIG. 1;

FIG. 4 illustrates a logical flow diagram of an exemplary embodiment of a method to authenticate a user for use of a legacy application using the system of FIG. 1;

FIG. 5 illustrates a flow chart of an exemplary embodiment of a method to authenticate a user for use of a legacy application using the system of FIG. 1;

FIG. 6 illustrates a relational diagram showing the relationship between applications, roles, permission, groups, users, thresholds, and alerts used in the system of FIG. 1, in accordance with an embodiment; and

FIG. 7 illustrates an exemplary embodiment of a screen shot of the thresholds and alerts functionality used in the system of FIG. 1.

### DETAILED DESCRIPTION

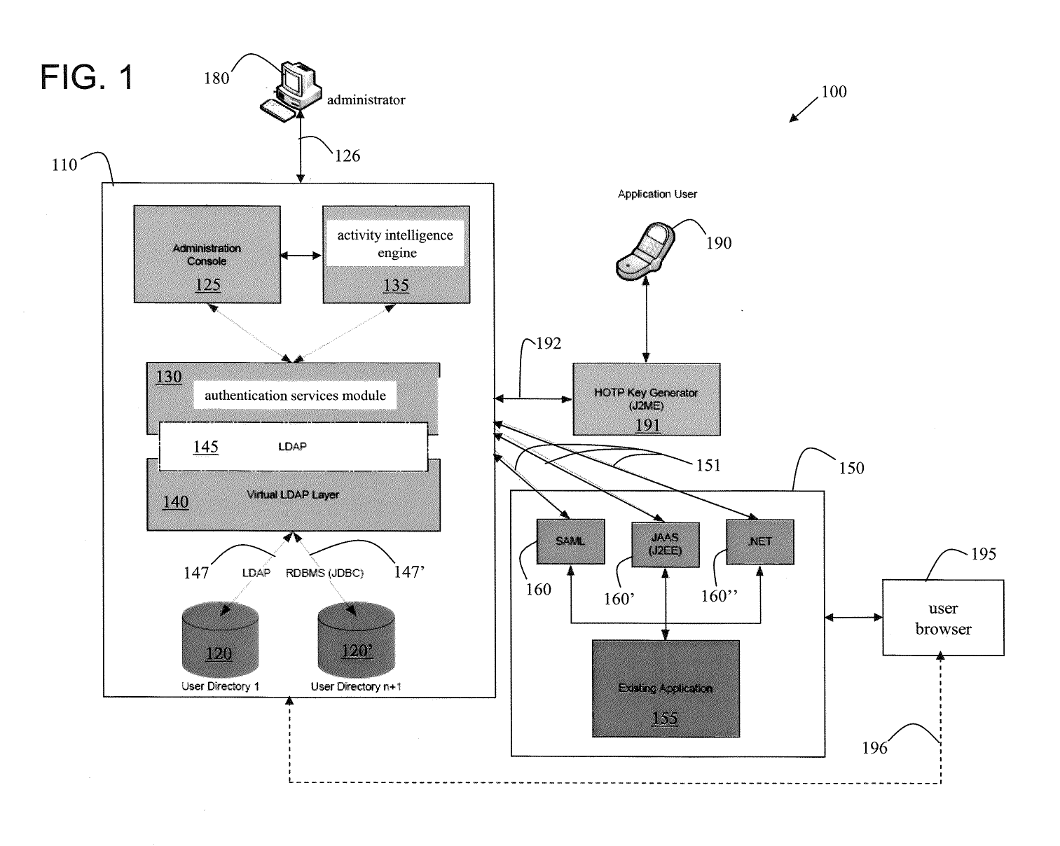

FIG. 1 illustrates a schematic block diagram of a logical view of an exemplary embodiment of a system 100 providing identity management with respect to an existing legacy application 155. The system includes a server platform 110 (identity management server) hosting a fully integrated software-based identity management suite, and a server platform 150 hosting an existing legacy application 155 and operationally interfacing to the server platform 110. In accordance with an embodiment, the system 100 is based on open standards as much as possible. For example, such open standards may include SAML, HOTP, and LDAP which are defined and discussed later herein. The identity management server 110 and the server platform 150 may be located remotely from each other or may exist on the same network at a client (service provider) site. In accordance with an embodiment, the legacy application 155 is an existing Multiple Listing Service (MLS) used in real estate which is provided by the service provider. Other applications 155 are possible as well.

The server platform 110 hosting the fully integrated software-based identity management suite provides domain administration services, authentication services, activity intelligence services, access to a user directory, mapping of user directory fields to server platform fields, communication of the server platform fields to the authentication services, user-friendly communication between the server platform 110 and an external administrator computer-based platform, communication with the external legacy server 150 hosting the legacy application 155, and support for one time pass code provisioning.

The system 100 also includes at least one administrator computer-based platform 180 operationally interfacing to the server platform 110. An administrator or system provider has access to the administrator computer-based platform 180 to administer the identity management suite by, for example, monitoring activity and making any changes or updates. The administrator is the service provider, in accordance with an embodiment. The system 100 further includes at least one wireless device 190 wirelessly interfacing to the server platform 110 to provide HOTP (heuristic one time password algorithm) provisioning to the wireless device. The wireless device may be a cell phone, a personal digital assistant (PDA), a blackberry, or some other wireless communication device. Alternatively, the system 100 includes at least one user computer-based platform (not shown) operationally interfacing to the server platform 110 to provide HOTP provisioning to the computer-based platform.

The server platform 110 may include at least one legacy user directory 120 (120′) that plugs into the server platform 110 and stores user information. The legacy user directory 120 is an existing directory (e.g., in the form of a database) that has been transferred (plugged in) to the server platform 110. Alternatively, the legacy user directory 120 may exist as part of the server platform 150.

The software-based identity management suite hosted on the server platform 110 includes an administration console 125 for domain administration to manage users and groups. The administration console 125 may be web-based, in accordance with an embodiment, and an administrator may access the identity management server 110 through a web browser on the administrator computer-based platform 180 (e.g., a PC). For example, the administration console 125 may use AJAX which provides more flexibility in administrator operability over the internet. AJAX is a web development technique used for creating interactive web applications. The administration console 125 includes an administrator user interface 126 adapted to provide user-friendly web-based communication between the server platform 110 and the administrator computer-based platform 180 via, for example, screen shots, menus, etc.

The software-based identity management suite also includes an authentication services module 130 for user authentication. The software-based identity management suite further includes an activity intelligence engine 135 for monitoring user activity and performing usage auditing and metrics. Usage auditing and metrics parameters are defined in the activity intelligence engine 135.

The identity management suite further includes an open-source-based layer (e.g., a virtual LDAP (Lightweight Directory Access Protocol) layer) 140 for mapping fields of the legacy user directory 120 (120′) to defined fields within the software-based identity management suite. The software-based identity management suite further includes an internal interface 145 using an open communication protocol (e.g., an internal LDAP communication protocol interface) adapted to provide communication between the virtual LDAP layer 140 and the authentication services module 130. The fields may hold data corresponding to user names, user passwords, and personal identification numbers. Other fields may hold data corresponding to legacy applications, roles, permissions, groups, users, thresholds, and alerts, as is discussed later herein.

The software-based identity management suite also includes an application program interface (API) 147 (147′) capable of facilitating access to the legacy user directory 120 (120′). The legacy user directory may be, for example, a LDAP directory 120 or active directory, or a Java-based directory 120′ such as a relational database (RDBMS). Correspondingly, the API 147 may be a LDAP API 147 or a Java-based relational database API 147′. If a legacy user directory is not provided by the service provider of the existing application 155, the identity management server 110 may provide a default user directory. A user directory may store users (name, address, phone numbers, etc.), groups (one or more users), applications (to be authenticated), permissions which tie groups and applications together logically, as well as other information.

The software-based identity management suite also includes a HOTP key generator 191 which may be downloaded from the server platform 110 to the wireless device 190 via a wireless network interface 192 of the server platform 110 or, alternatively, to the user computer-based platform. The HOTP key generator 191 (HOTP algorithm) is typically a midlet such as a small Java application (such as a Java2, micro edition (J2ME) midlet) that is supported by mobile devices such as a cell phone, a PDA, and a blackberry, for example. The wireless network interface 192 is only active at the time of HOTP provisioning.

The identity management server 110 and the server platform 150 may communicate using an XML-based protocol, in accordance with an embodiment. The software-based identity management suite may include a secure web-based connection 151 (e.g., an XML-based protocol interface) to communicate with the server platform 150. The server platform 150 hosts the existing legacy server application 155 and further may include at least one application program interface (API) (160, 160′, 160″) capable of delivering user identification information to the server platform 110 and capable of receiving legacy user directory information from the server platform 110 in response to the delivered user identification information. The application program interface may comprise a SAML-based API 160, a Java-based (e.g, J2EE) API 160′, or a NET-based API 160″, in accordance with various embodiments. Other API's are possible as well, however.

SAML (Security Assertion Markup Language) is a web service XML standard for exchanging authentication and authorization data between security domains such as between an identity provider (i.e., the identity management server 110) and a service provider (i.e., the administrator and the server platform 150 with the existing legacy application 155). Similary, J2EE and .NET are web services based on XML. If the legacy application 155 is written in Java, then the Java-based API 160′ is used and plugs into the server platform 150. Similarly, if the legacy application 155 is written in .NET, then the NET-based API 160″ is used and plugs into the server platform 150. There are existing legacy applications (e.g., certain Multiple Listing Services) that are already compatible with SAML and do not require a dedicated API 160.

The system 100 also includes a user browser 195 allowing a user to access the legacy server platform 150, for example, via a personal computer (PC). When a user wants to access the existing legacy application 155 on the server platform 150, the server platform 110 hosting the software-based identity management suite provides the identification and authentication services to allow or deny access to the user, as is described in more detail herein below.

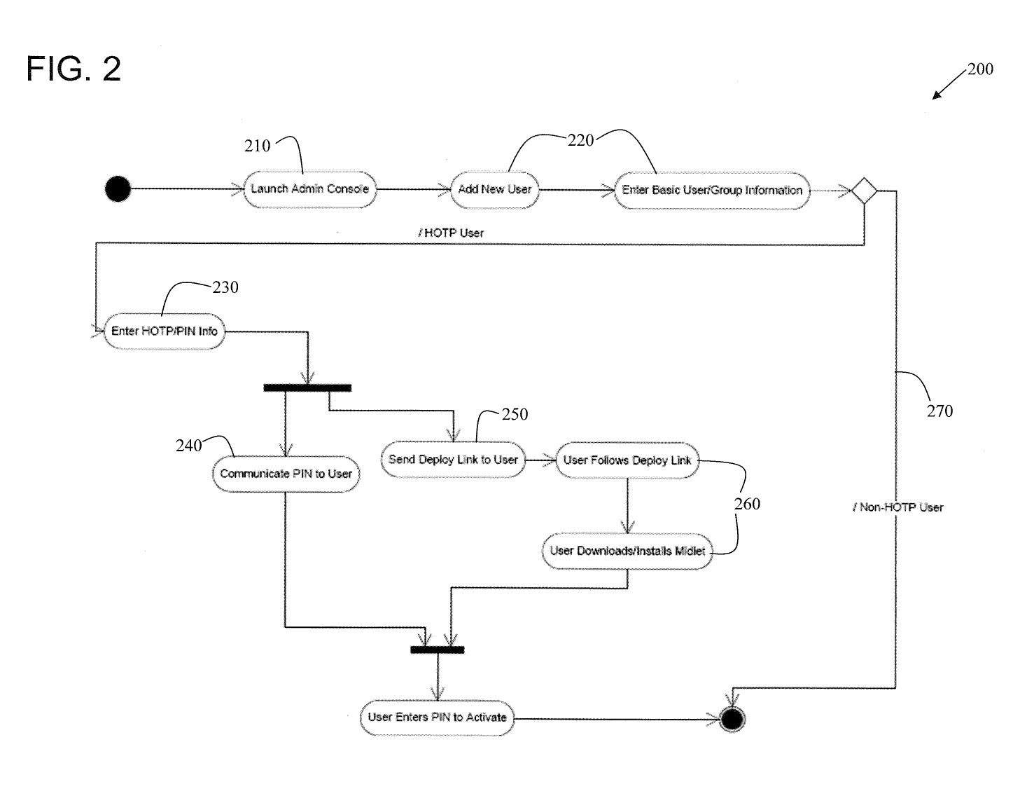

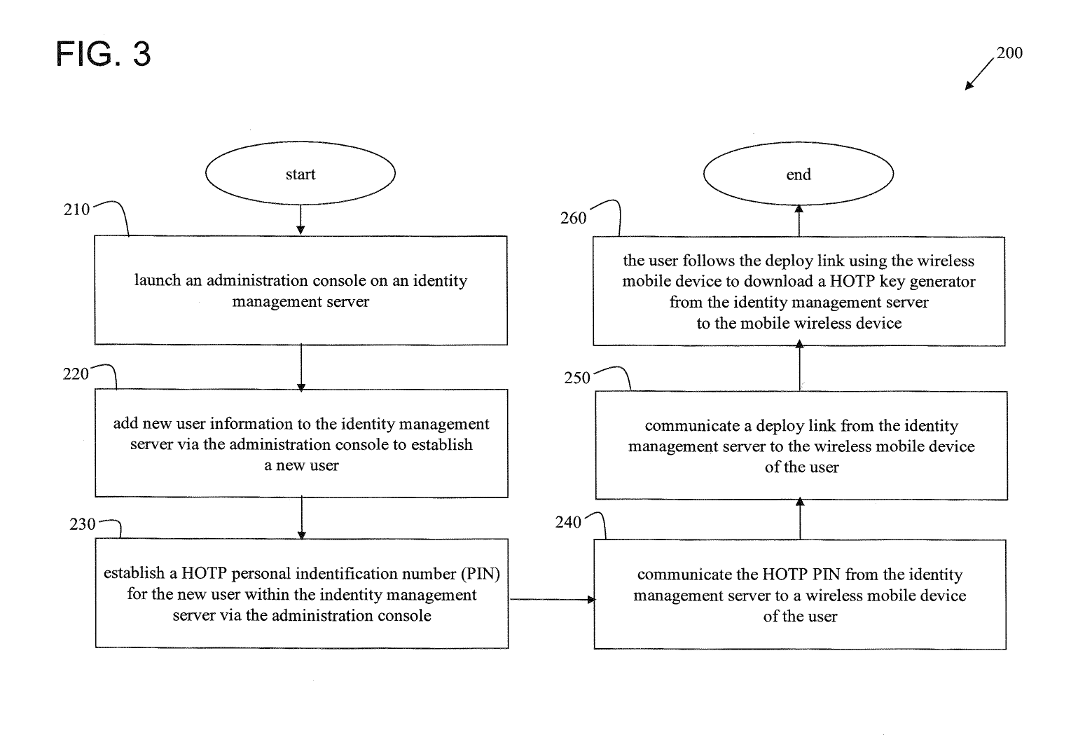

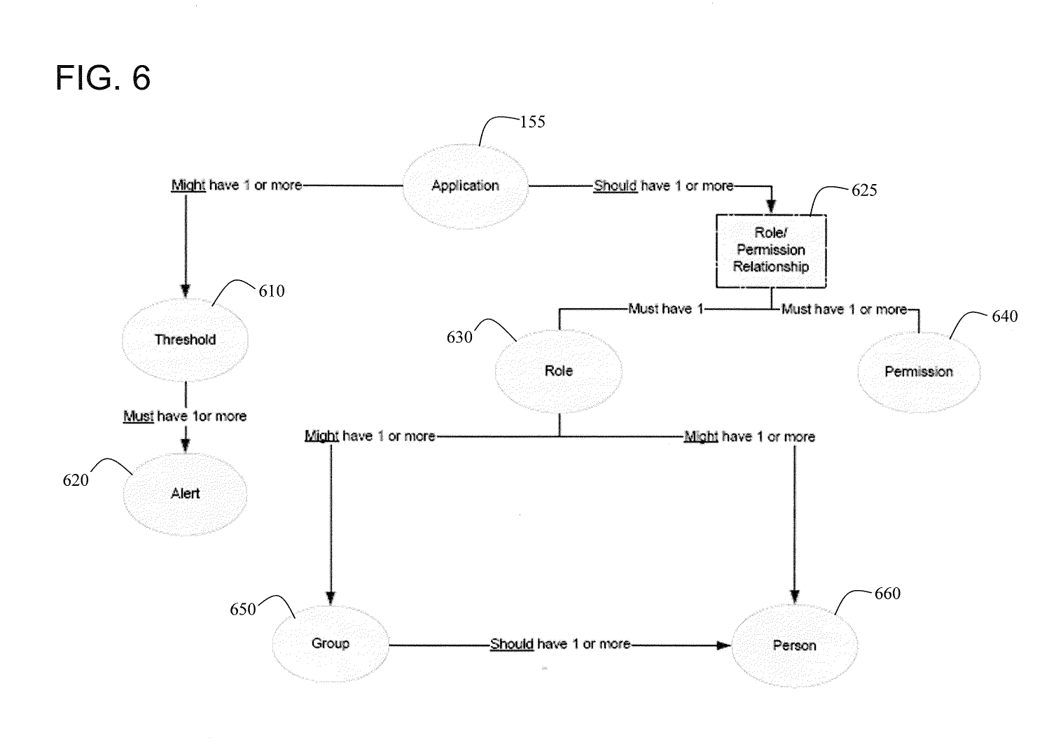

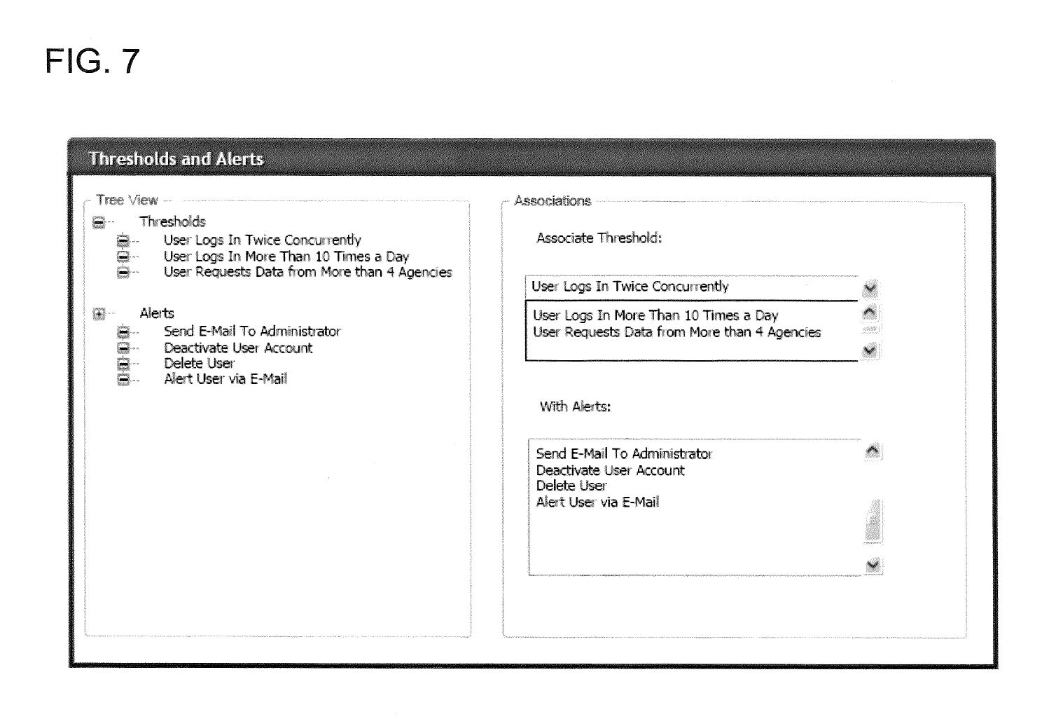

FIG. 2 illustrates a logical flow diagram of an exemplary embodiment of a method 200 of creating and provisioning a new user in the system 100 of FIG. 1. FIG. 3 illustrates a flow chart of an exemplary embodiment of the method 200 of creating and provisioning a new user in the system 100 of FIG. 1. In step 210 of the method 200, the administration console 125 is launched on the identity management server 110 by an administrator using the administrator computer-based platform 180. In step 220, new user information corresponding to a new user is added to the identity management server 110 via the administration console 125 to establish the new user. In accordance with an embodiment, the new user information includes data representing the legacy application 155 for the user, at least one threshold associated with the legacy application 155, at least one alert associated with the threshold, a user name and password, a group associated with the user name and password, a role associated with the group, and a permission associated with the role. Thresholds, alerts, groups, roles, and permissions are discussed in more detail herein below with reference to FIG. 6 and FIG. 7.

In step 230 of the method 200, a HOTP personal identification number (PIN) is established for the new user within the identity management server 110 via the administration console 125. In step 240, the HOTP PIN is communicated from the identity management server 110 to the wireless mobile device 190 (or PC) of the user (e.g., via a SMS cell phone number for texting or via an email address). In step 250, a deploy link is communicated from the identity management server 110 to the wireless mobile device 190 (or PC) of the user. In step 260, the user follows the deploy link using the wireless mobile device 190 (or PC) to download the HOTP key generator 191 from the identity management server 110 to the wireless mobile device 190 (or PC).

The user may then enter the HOTP PIN via the wireless mobile device 190 to activate the HOTP key generator 191 on the wireless mobile device 190 to generate a one time HOTP user pass code. The HOTP user pass code may comprise a five or six digit number, for example. The HOTP PIN is entered by the user to generate a HOTP user pass code every time the user desires to access the application 155 (for two-factor identification). As shown in FIG. 2, certain users may be non-HOTP users and, therefore, follow a non-HOTP path 270 that does not involve generating a HOTP user pass code. Once a new user is set up on the system 100, the new user may access the existing legacy application 155 residing on the server platform 150.

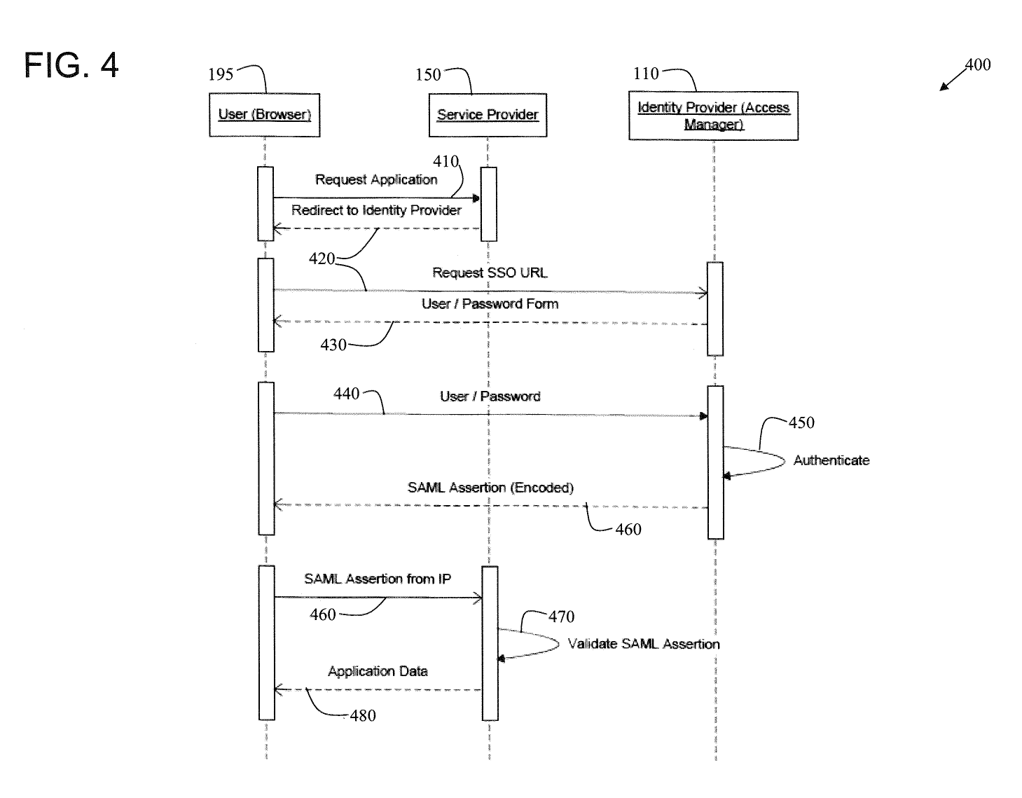

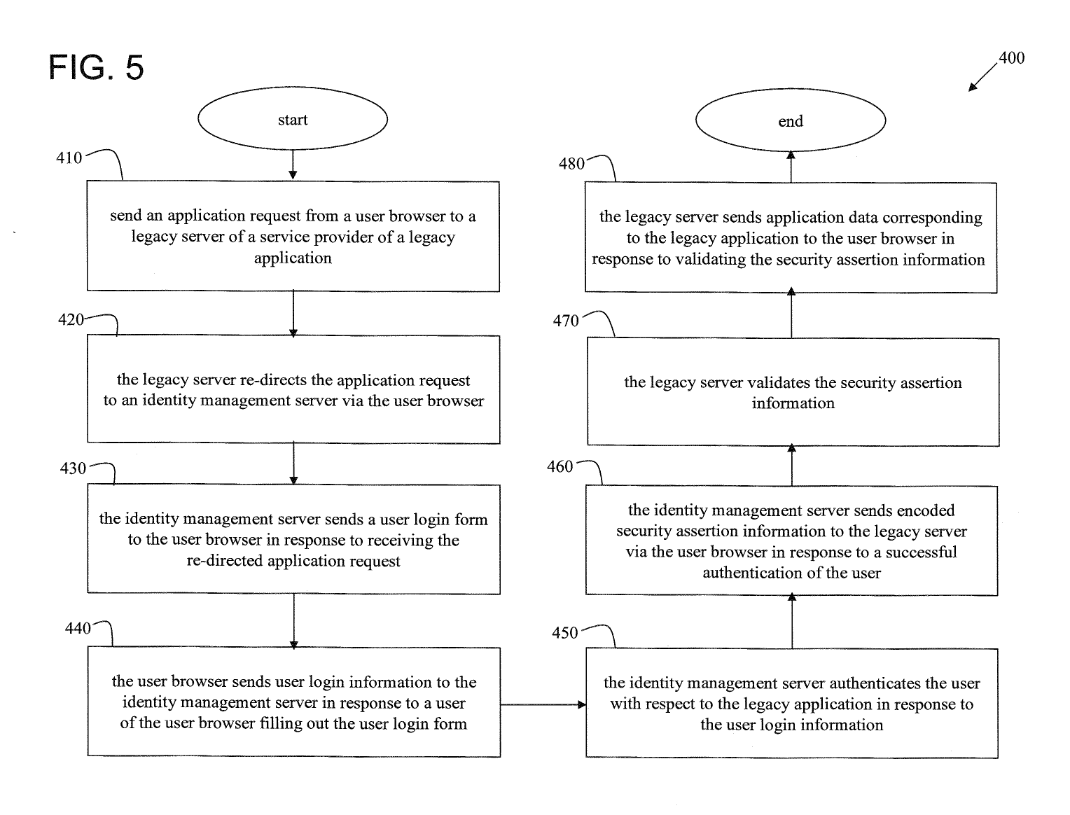

FIG. 4 illustrates a logical flow diagram of an exemplary embodiment of a method 400 to authenticate a user for use of the legacy application 155 using the system 100 of FIG. 1. FIG. 5 illustrates a flow chart of an exemplary embodiment of the method 400 to authenticate a user for use of the legacy application 155 using the system 100 of FIG. 1. Note that, in the embodiment of the method 400 of FIG. 4 and FIG. 5, an API (160, 160′, or 160″) in the server 150 communicating with the server 110 over the secure web-based connection 151 may not be present. Instead, secure communication takes place directly between the user browser 195 and the server 110 over a communication link 196 using, for example, a SAML-enabled communication protocol.

In step 410, an application request is sent from the user browser 195 to the legacy server 150 of a service provider of the legacy application 155. That is, the user is requesting access to the legacy application 155 (e.g., a MLS application) on the legacy server 150. In step 420, the legacy server 150 re-directs the application request to the identity management server 110 via the user browser 195. In step 430, the identity management server 110 sends a user login form to the user browser 195 in response to receiving the re-directed application request. In step 440, the user browser 195 sends user login information to the identity management server 110 in response to the user of the user browser 195 filling out the user login form. In accordance with an embodiment, the user login information includes a user name, a user password, and a HOTP user pass code for two-factor identification. As an alternative, the user login information includes only a user name and a user password (e.g., for non-HOTP users). However, requiring a unique HOTP user pass code every time the user (e.g., a real estate agent) attempts to access the application 155 (e.g., a MLS) helps prevent the user from allowing others (e.g., other real estate agents) to access the application 155 by simply giving the others his user name and password.

In step 450, the identity management server 110 authenticates the user with respect to the legacy application 155 in response to the user login information. In step 460, the identity management server 110 sends encoded security assertion information to the legacy server 150 via the user browser 195 over the link 196 in response to a successful authentication of the user. In accordance with an embodiment, the security assertion information includes user directory information obtained from the legacy user directory (e.g., 120) on the identity management server 110 as part of the authenticating step 450. As an alternative, the security assertion information may include user directory information obtained from a legacy user directory on the legacy server 150 as part of the authenticating step 450. The user directory information may include data representing the legacy application for the user, a user name and password, a group associated with the user name and password, a role associated with the group, and a permission associated with the role. In step 470, the legacy server 150 validates the security assertion information. In step 480, the legacy server 150 sends application data corresponding to the legacy application 155 to the user browser 195 in response to validating the security assertion information.

FIG. 6 illustrates a relational diagram showing the relationship between applications, roles, permission, groups, user, thresholds, and alerts used in the system of FIG. 1, in accordance with an embodiment. The activity intelligence engine 135 performs activity intelligence (usage auditing and metrics) in the background as user requests are coming in and being processed. A transaction log of authentication requests and information from the existing application 155 is kept. The activity intelligence engine 135 operates on the transaction log to determine if there are any security problems. If a person attempts to access the application 155 on the server platform 150 several times and the attempts fail due to, for example, an incorrect user name, password, or HOTP user pass code entered by the person, a threshold condition 610 may be met within the activity intelligence engine 135 of the identity management server 110. Once the threshold condition 610 is met, an alert 620 is triggered in response to the threshold condition 610 being met. The alert 620 is generated based on the assumption that an unauthorized user may be attempting to access the server platform 150.

For example, a first threshold may correspond to a user logging in twice concurrently. A second threshold may correspond to a user logging in more than ten times a day. A third threshold may correspond to a user requesting data from more than four agencies. An alert 620 may take the form of an email that is automatically sent by the identity management server platform 110 to a designated person (e.g., the administrator) or an email that is automatically sent to the person or user attempting to access the server platform 150. An alert 620 may also take the form of an action by the identity management server platform 110 such as temporarily de-activating the user or deleting the user from the server platform 110. An application 155 may have zero, one, or more thresholds associated with it, and meeting a threshold results in one or more alerts.

The user directory 120 stores defined relationships between applications, roles, permissions, groups, and users. The service provider, as the administrator, sets up desired users, groups, thresholds, etc. An application 155 has one or more relationships 625 between roles and permissions. For example, an application 155 may have one role 630 and one or more permissions 640. Roles and permissions define actions available to users. A unique permission governs each user action. Permissions may be used collectively in roles. Roles are assigned to users, granting users the permissions associated with a role. Roles may also be assigned to user groups. A role may be associated with one or more groups 650 or one or more persons (users) 660. A group 650 may include one or more users 660. A user 660 is an individual person who has either registered with the server platform 150 via the identity management server 110 or who has a user account created by the administrator 180. Each user has a unique user name and password and each user holds one or more roles. Each role includes an assigned set of permissions. A permission may be defined as, for example, a normal user, a super user, or an administrator. The administrator defines access rights and interaction rules for individual users and groups of users. User groups 650 are often formed to grant roles and permissions to a set of users at one time. FIG. 7 illustrates an exemplary embodiment of a screen shot of the thresholds and alerts functionality used in the system of FIG. 1.

In accordance with an embodiment, the software-based identity management suite may be stored on a computer readable medium such as a computer disk (e.g., CD, DVD, hard disk), a tape, a memory stick, etc. for transport, and may be loaded from the computer readable medium onto the identity management server platform 110. The software-based identity management suite may include a first data structure comprising a first field capable of containing data representing a user name, a second field capable of containing data representing a user password, and a third filed capable of containing data representing a HOTP personal identification number, for example. Other fields are possible as well. The software-based identity management suite may include a second data structure comprising a first field capable of containing data representing a legacy application, a second field capable of containing data representing a role, at least a third field capable of containing data representing at least one permission, at least a fourth field capable of containing data representing at least one group, and at least a fifth field capable of containing data representing at least one user. The software-based identity management suite may include a third data structure comprising a first field capable of containing data representing a legacy application, at least a second field capable of containing data representing at least one threshold, and at least a third field capable of containing data representing at least one alert.

In summary, a system, methods, and an integrated software suite hosted on a server platform for providing identity management with respect to use of a legacy application are disclosed. The integrated software suite constitutes a cohesive integrated product that may be used by service providers in conjunction with their own legacy applications hosted on their own servers. Such an integrated software suite leverages open source protocols and plug-in legacy directories and is easily configurable by a service provider such that the service provider can avoid having to perform complex and time-consuming identity management integration themselves.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A server platform hosting an integrated software-based identity management suite comprising:
an administration console for domain administration;
an authentication services module for user authentication;
an activity intelligence engine for monitoring user activity;
an open-source-based virtual layer for mapping fields of a legacy user directory to fields within said server platform; and
an internal interface using an open communication protocol adapted to provide communication between said open-source-based virtual layer and at least said authentication services module within said server platform.

2. The server platform of claim 1 wherein said open-source-based virtual layer comprises a virtual LDAP layer.

3. The server platform of claim 2 wherein said open communication protocol comprises an LDAP communication protocol.

4. The server platform of claim 1 further comprising a legacy user directory.

5. The server platform of claim 4 further comprising an application program interface (API) capable of facilitating access to said legacy user directory.

6. The server platform of claim 1 wherein said administration console includes an administrator user interface adapted to provide user-friendly web-based communication between said server platform and an external administrator computer-based platform.

7. The server platform of claim 1 wherein said identity management suite includes an XML-based protocol interface to communicate with an external legacy server hosting a legacy application.

8. The server platform of claim 1 wherein said administration console further supports HOTP provisioning.

9. The server platform of claim 1 further comprising a wireless network interface supporting HOTP provisioning.

10. A computer readable medium having stored thereon an integrated software suit for identity management, said integrated software suite comprising:
an administration console for domain administration;
an authentication services module for user authentication;
an activity intelligence engine for monitoring user activity;
an application program interface (API) capable of facilitating access to a legacy user directory;
a virtual LDAP layer for mapping fields of said legacy user directory to defined fields within said software suit; and
an internal LDAP communication protocol interface adapted to provide communication between said virtual LDAP layer and said authentication services module.

11. The integrated software suite of claim 10 wherein said administration console includes an administrator user interface adapted to provide user-friendly web-based communication between a server platform hosting said software suite and an external administrator computer-based platform.

12. The integrated software suite of claim 10 further comprising an XML-based protocol interface to communicate with an external legacy server hosting a legacy application.

13. A server platform hosting an integrated software-based identity management suite comprising:
means for providing domain administration services;
means for providing authentication services;
means for providing activity intelligence services;
means for facilitating access to a legacy user directory;
means for mapping legacy user directory fields to server platform fields; and
means for communicating said server platform fields to said means for providing authentication services.

14. The server platform of claim 13 further comprising means for providing user-friendly communication between said server platform and an external administrator computer-based platform.

15. The server platform of claim 13 further comprising means for communicating with an external legacy server hosting a legacy application.

16. A system providing identity management with respect to a legacy application, said system comprising:
a first server platform hosting an integrated software-based identity management suite;
at least one administrator computer-based platform operationally interfacing to said first server platform; and
a second server platform hosting a legacy application and operationally interfacing to said first server platform via a secure web-based connection.

17. The system of claim 16 wherein said first server platform includes at least one legacy user directory.

18. The system of claim 16 wherein said second server platform includes at least one legacy user directory.

19. The system of claim 16 further comprising at least one wireless device wirelessly interfacing to said first server platform to provide HOTP provisioning to said wireless device.

20. The system of claim 16 further comprising at least one user computer-based platform operationally interfacing to said first server platform to provide HOTP provisioning to said computer-based platform.

21. The system of claim 16 wherein said software-based integrated identity management suite comprises:
an administration console for domain administration;
an authentication services module for user authentication;
an activity intelligence engine for monitoring user activity;
a virtual LDAP layer for mapping fields of a legacy user directory to defined fields within said software suit; and
an internal LDAP communication protocol interface adapted to provide communication between said virtual LDAP layer and said authentication services module.

22. A method to authenticate a user for use of a legacy application hosted on a legacy server, said method comprising:
sending an application request from a user browser to a legacy server of a service provider of a legacy application;
said legacy server redirecting said application request to an identity management server via said user browser;
said identity management server sending a user login form to said user browser in response to receiving said redirected application request;
said user browser sending user login information to said identity management server in response to a user of said user browser filling out said user login form;
said identity management server authenticating said user with respect to said legacy application in response to said user login information;
said identity management server sending encoded security assertion information to said legacy server via said user browser in response to a successful authentication of said user;
said legacy server validating said security assertion information; and
said legacy server sending application data corresponding to said legacy application to said user browser in response to validating said security assertion information.

23. The method of claim 22 wherein said user login information includes a user name, a user password, and a HOTP user pass code.

24. The method of claim 22 wherein said security assertion information includes user directory information obtained from a legacy user directory on said identity management server as part of said authenticating step.

25. The method of claim 22 wherein said security assertion information includes user directory information obtained from a legacy user directory on said legacy server as part of said authenticating step.
